(19) United States
(12) Patent Application Publication
(10) Pub. No.: US 2006/0132287 A1
(43) Pub. Date: Jun. 22, 2006

(54) Radio frequency identification interrogation method and radio frequency identification device

(75) Inventors: William Phipps, Fairport, NY (US); Scott Jonathan Bell, Rochester, NY (US); Alberto Rodriguez, Webster, NY (US); Heiko Rommelmann, Penfield, NY (US); Ronald P. Boucher, Rochester, NY (US)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/012,480

(22) Filed: Dec. 16, 2004

(51) Int. Cl. H04Q 5/22

(52) U.S. Cl. 340/10.1; 340/572.7; 340/10.42; 340/10.5; 455/277.1

(57) ABSTRACT

A radion frequency identification method and device may facilitate communication between a host computer and a plurality of radio frequency identification sensing antennas and their associated transponders. Incorporated within such a device may be an industry standard serial control bus interface, a standards based radio frequency protocol, and a plurality digital output ports. A state machine and decoding logic may be included to transform serially received antenna selection data and to configure the digital output ports to enable one of the plurality of sensing antennas.

Co-pending applications with attorney docket numbers 120609, 120610, 120611, 120612, 120635, 120636 and 120641 are incorporated herein in their entirety by reference thereto.

### BACKGROUND

This invention is related to radio frequency identification devices, and more specifically relates to radio frequency identification coupler devices and methods for interrogating radio frequency identification transponders.

Replaceable unit monitors (RUMs) are increasingly being used in machines to monitor the status of replaceable sub-assemblies, otherwise known as consumer replaceable units (CRUs). Printers, copiers, fax machines, and image forming apparatus in general may have a number of CRUs including fuser modules, print cartridges and toner bottles. A radio frequency identification transponder, or tag, mounted on each sub-assembly may communicate with a unique coupler device via a dedicated antenna in close proximity to the radio frequency identification tag.

With today's technology, a RUM would likely require the use of more than one coupler chip. Due to physical geography, there may be a 1:1 relationship with the number of radio frequency identification tags in a system and the number of coupler chips. Therefore, as the number of replaceable sub-assemblies within a machine increases, the number of radio frequency identification tags, coupler devices and antennas increases accordingly, resulting in an increase in size, complexity and cost.

Industry has responded to this problem by designing circuits, external to the particular coupler chip in use, that may detect bus commands outside the standard command set. These unique commands may then be used to address a particular output of an analog demultiplexer or switching circuit. The demultiplexer may route a radio frequency RF output of the coupler chip to a desired antenna.

An exemplary system and method for controlling communications in a security system based upon radio frequency identification techniques is discussed in U.S. Patent Application Publication No. 2004/0160309. The radio frequency identification reader is provided with multiple modulation techniques, multiple antennas, and the capability to vary its power level and carrier frequency.

U.S. Patent Application Publication No. 2003/0141962 discloses an apparatus and method for locating a radio frequency identification transponder and includes a plurality of antenna for receiving identification data broadcast by the radio frequency identification transponder.

Another method and apparatus for tracking items with a radio frequency identification tag is disclosed by U.S. Pat. No. 6,714,121. This patent includes passive radio frequency identification tags, interrogators with several antenna inputs connected to the sensing antennas to multiplex the antenna signals, and a host computer in communication with the interrogators.

Another radio frequency identification system is disclosed by U.S. Pat. No. 6,600,420, which includes multiple antennas, at least one of which may be selected to facilitate the interrogation of radio frequency identification elements, and a control system for addressing antennas sequentially so that the antenna system may determine the order of the tagged items.

U.S. Pat. No.6,317,027 further discloses a proximity reader for a radio frequency identification system which is programmed for determining and storing optimum antenna impedance values to achieve peak antenna resonance at each of multiple operating frequencies.

U.S. Pat. No.6,069,564 discloses a design of a multi-directional RF antenna comprising a plurality of coils adapted to communicate with a source, such as a radio frequency identification tag. The antenna includes a switch for selecting at least one of the RF antenna coils for transmission of RF signals and receipt of RF response signals.

Each of the foregoing references is incorporated by reference in its entirety.

### SUMMARY

Exemplary embodiments of a radio frequency identification interrogation method and device may incorporate an industry standard serial data control bus interface, a standards based radio frequency protocol, and sensing antenna selection logic within a single semiconductor device. Such embodiments may simplify the design of radio frequency identification readers by reducing the number of coupler devices, support circuitry and connectors required to select one of a plurality of radio frequency identification sensing antennas.

An exemplary serial data interface may communicate with an industry compliant I²C bus design which allows integrated circuits to communicate directly with each other via a simple bi-directional two-wire (plus ground) bus. The I²C bus may comprise of two active wires and a ground connection. The active wires, the Serial Data line (SDA) and the Serial Clock line (SCL), may both be bi-directional.

Each device connected to an I²C bus may be identifiable by a unique address, and may operate as either a transmitter or a receiver, or both. Data transfers may be accomplished using a master-slave protocol. A master is a device that initiates a data transfer and generates the clock signals to permit the transfer; any device that is addressed is considered a slave for that data transfer. The data transfer may be initiated by a master to either transmit data to the slave (write), or to request data from the slave (read). A particular device may be capable of operating as a master, a slave, or both.

Exemplary embodiments of the radio frequency identification device function as a slave device to a host computer or ASIC. In one exemplary embodiment, the radio frequency identification device may be fabricated as a single semiconductor chip mounted on a printed circuit board (PWB) with other electronic components. The radio frequency identification device, receives both device selection and antenna selection data bytes from the host computer over the serial bus. Upon proper selection by the host computer, the radio frequency identification device transforms the antenna selection data byte to three digital signals to be transmitted on three digital output ports. The three digital signals may then drive the select lines of a 1:8 channel analog switch which gates the RF output of the radio frequency identification device to the appropriate sensing antenna circuit. Each antenna circuit drives an RF antenna in close proximity to an inductively coupled radio frequency identification transponder.

An inductively coupled radio frequency identification transponder, or RF tag, may comprise an electronic data-carrying device, such as a single microchip, and a relatively large area coil that functions as an antenna. Under control of an onboard microchip, a targeted transponder may transmit a digital message by changing the characteristic impedance of it's antenna, thereby inducing a change in the RF signal driving the sensing antenna. The radio frequency identification device, or coupler, demodulates the induced digital message and transmits the message to the host computer over the I²C interface.

Exemplary embodiments may simplify radio frequency identification reader circuitry and may be implemented in RFID system designs for printers, fax machines, copiers, and all apparatus which monitor radio frequency identification transponders.

### BRIEF DESCRIPTION OF THE DRAWINGS

Various exemplary embodiments are described in detail, with reference to the following figures, wherein:

FIG. 1 is a block diagram illustrating an exemplary radio frequency identification device.

FIG. 2 illustrates a representative schematic of an exemplary replaceable unit monitor (RUM) system incorporating the radio frequency identification device of FIG. 1.

FIG. 3 illustrates an environmental drawing of an exemplary image forming apparatus incorporating the radio frequency identification device of FIG. 1 and the RUM system depicted in the block diagram of FIG. 2.

FIG. 4 illustrates an exemplary interrogation sequence between a host device and the radio frequency identification device of FIG. 1.

### DETAILED DESCRIPTION OF EMBODIMENTS

The following detailed description of exemplary embodiments is particularly directed to a radio frequency interrogation device comprising an industry standard serial data interface, a standards based radio frequency protocol, and digital output ports which may be used to select one of a plurality of sensing antennas selection logic. In the exemplary embodiments, the radio frequency identification device is fabricated as a single semiconductor device and may be disposed in an image forming device, such as a printer or copier. Thus, the following detailed description makes specific reference to image forming devices and their components. However, it should be understood that radio frequency identification devices and methods may be used in conjunction with other apparatus having at least one radio frequency identification antenna and transponder, and that the exemplary embodiments described herein are not limiting.

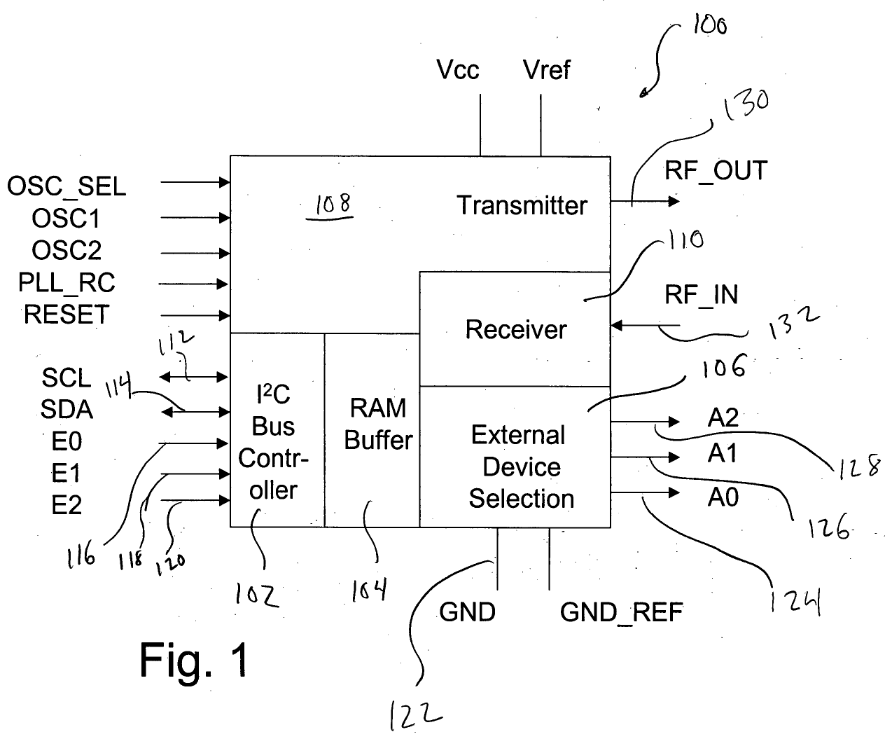

As illustrated in FIGS. 1, an exemplary radio frequency identification device 100 may include an industry compliant I²C bus controller 102, a RAM buffer 104 configured as a collection of registers, external device selection logic 106, an analog transmitter 108 and an analog receiver 110. The analog transmitter 108 and the analog receiver 110 may be compliant with the ISO/IEC 14443 recommendations for a radio-frequency power and signal interface.

The bus controller 102 may use a limited number of electrical lines for communication with electronic devices sharing the common bus and may be compliant with the 400 kHz I²C bus specification known to those knowledgeable in the field. The serial bus may shift data in and/or out of electronics being controlled in a pre-determined protocol and may control read/write access to all radio frequency identification device registers.

The I²C bus controller 102 may interface with an I²C bus (not shown), via a serial data line (SDA) 114, a serial clock line (SCL) 112, a power connection and a ground connection 122. The SDA and SCL lines may both be bi-directional. Three device enable ports E0-E2, when tied to appropriate voltage levels via signals 116-120, may determine the address of the radio frequency identification device 100 to be used by other I²C devices when communicating with the radio frequency identification device 100 over the I²C bus.

The RAM buffer 104 may also be bi-directional. The RAM buffer 104 may store the request frame bytes to be transmitted via the analog transmitter 108 and bytes received by the analog receiver 110 in answer to a request for data.

The external device selection logic 106 may receive external device selection data from the I²C bus controller 102 and transforms the serially received data into three digital output signals 124-128 presented on output ports A0-A2. Although the external device select data byte received by the I²C bus controller 102 is 8-bits wide in this example, only 3-bits may be needed to select one of eight devices. It should be understood that although the present embodiment utilizes 3-bits, this number is exemplary and non-limiting. For example, by incorporating all 8-bits with appropriate output ports, a single radio frequency identification device may select up to 128 external devices.

The transmitter block 108 may be capable of generating a RF magnetic field at 13.56 Mhz by transmitting an RF signal on the RF_OUT port 130 of the radio frequency identification device 100. The field may be modulated using ASK (amplitude shift keying) modulated for outgoing data, for example.

The receiver 110 may receive an RF signal on the RF_IN port 132. The receiver 110 may demodulate data induced on the RF signal 132. The data may be decoded, for example, by an 847 Khz BPSK (binary phase shift keying) sub-carrier decoder. A non-limiting list and description of ports on the radio frequency identification device 100 are listed in Table 1.

TABLE 1
Radio Frequency Identification Device Signal Names

| | |
|---|---|
| RF OUT | Radio Frequency Output |
| RF IN | Radio Frequency Input |
| VCC/GND | Power Supply & Ground |
| GND_REF | Ground for RF circuitry |
| OSC1/OSC2 | Oscillator input |
| PLL_RC | Phase Lock Loop RC filter Input |
| VREF | Transmitter/Receiver Reference Voltage |
| OSC_SEL | 13.56 Mhz/32.768 kHz oscillator select |
| RESET | Reset |
| SCL | I²C Clock |
| SDA | I²C Bi-directional Data |
| A0 | Device Select Line 0 |
| A1 | Device Select Line 1 |
| A2 | Device Select Line 2 |
| E0 | I²C Chip Enable |
| E1 | I²C Chip Enable |
| E2 | I²C Chip Enable |

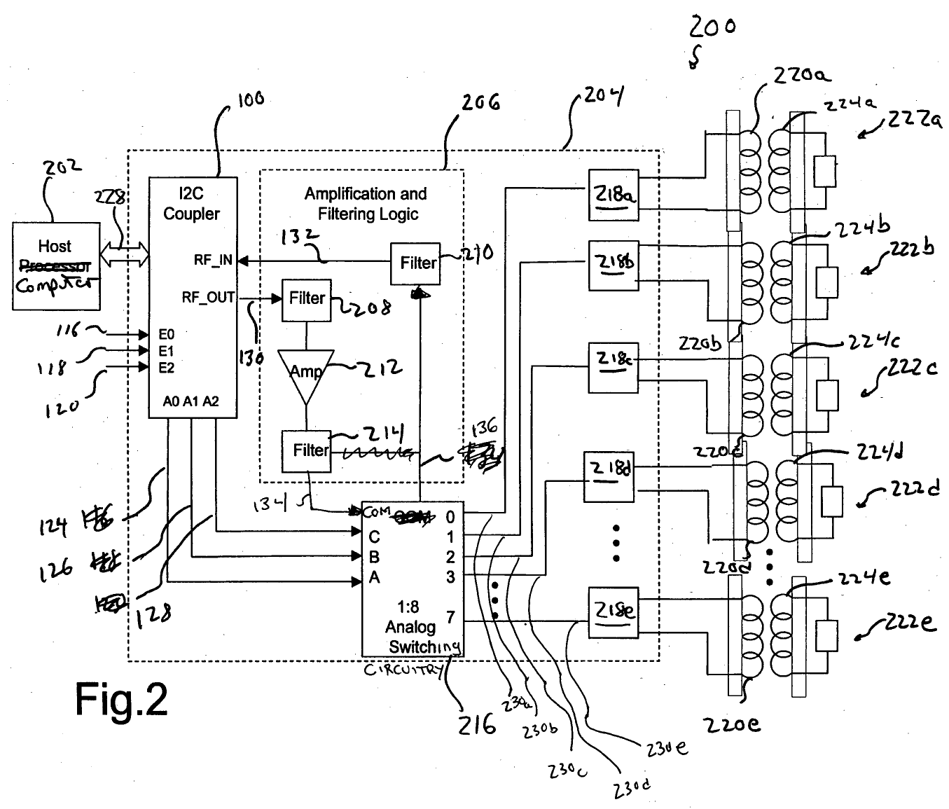

FIG. 2 illustrates an exemplary block diagram of a RUM reader system 200 capable of interrogating up to eight radio frequency identification transponders, five being shown in FIG. 2 as transponders 222a-e. The RUM reader 200 may include a host computer 202, radio frequency identification device 100, amplification and filtering logic 206 and analog switching circuitry 216. The transponders 222a-e may be mounted on CRU's (not shown). In close proximity to an associated one of the transponder 222a-e, a plurality of radio frequency identification sensing antennas 220a-e may be disposed. The five sensing antennas 220a-e may be in electrical communication with five corresponding antenna circuits 218a-e.

As shown in FIG. 2, the radio frequency identification device 100, the amplification and filtering logic 206, the analog switching circuitry 216 and the antenna circuits 218a-e may be mounted on a printed wiring board 204. It should be understood that the components disclosed in FIG. 2 need not be physically as described and shown. For example, the host computer 202 and/or the sensing antennas 220 may be collocated on the printed wiring board 204 or they may consist of their own assemblies and mounted remotely from each other within the hosting system.

The host computer 202 may be in electrical communication with the radio frequency identification device 100 over an I²C serial bus 228. The radio frequency identification device enable lines E0-E1 may be tied to appropriate signal levels so as to make the radio frequency identification device 100 recognizable to host computer 202. A series of filters 208, 210 and 214 and an amplifier 212 may be used to transform the RF output 130 of the radio frequency identification device 100 to a filtered RF signal 134.

Ports A0-A2 of the radio frequency identification device 100 may supply signals 124-128 to the analog switching circuitry 216 and may switch the filtered RF signal 134 to the appropriate one of the sensing antennas 220a-e. Analog switching circuitry to switch analog signals is known in the art and may comprise, for example, an analog gate or demultiplexer, such as the 8051 analog demultiplexer 216 shown in FIG. 2. Fabricated by several manufacturers, the 8051 is an 8-channel digitally controlled analog switch having low “on impedance” and three binary control inputs A, B and C. Tied to signals 124-128, analog switching circuitry 216 may gate the RF signal 134 to one of eight channels 0-7 based upon signals 124-128. The eight output channels 0-7 may be connected to eight antenna circuits, including; for example, the five circuits 218a-e shown in FIG. 2 via signals 230a-e. Analog switching circuitry 216 is exemplary only and alternate designs are possible.

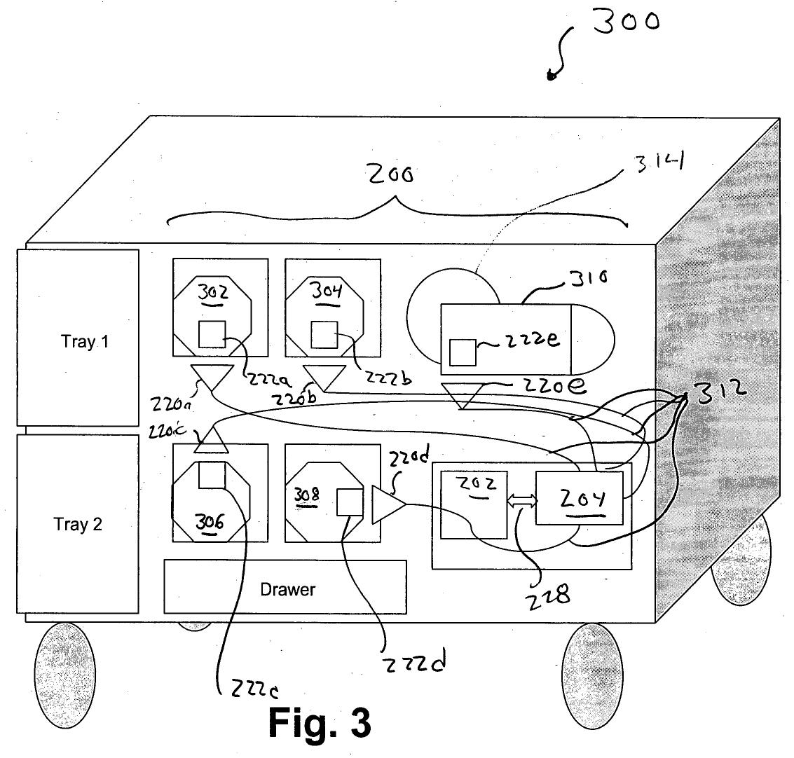

As shown in FIG. 3, an exemplary embodiment of an image forming apparatus 300 may include the radio frequency identification device 100 and the RUM reader 200 described above. The image forming apparatus 300 may be any suitable apparatus, such as a printer, copier, or facsimile machine. In addition to non-CRU components, such as a drum 314, the image forming apparatus 300 may include several CRU's, such as toner bottles 302-308 and a fuser module 310. Cables 312 may be used to connect the printed wiring board 204 to the sensing antennas 220a-e.

In exemplary operation, the reader 200 may monitor the status of radio frequency identification transponders mounted on toner bottles 302-308, fuser module 310, and other CRU's.

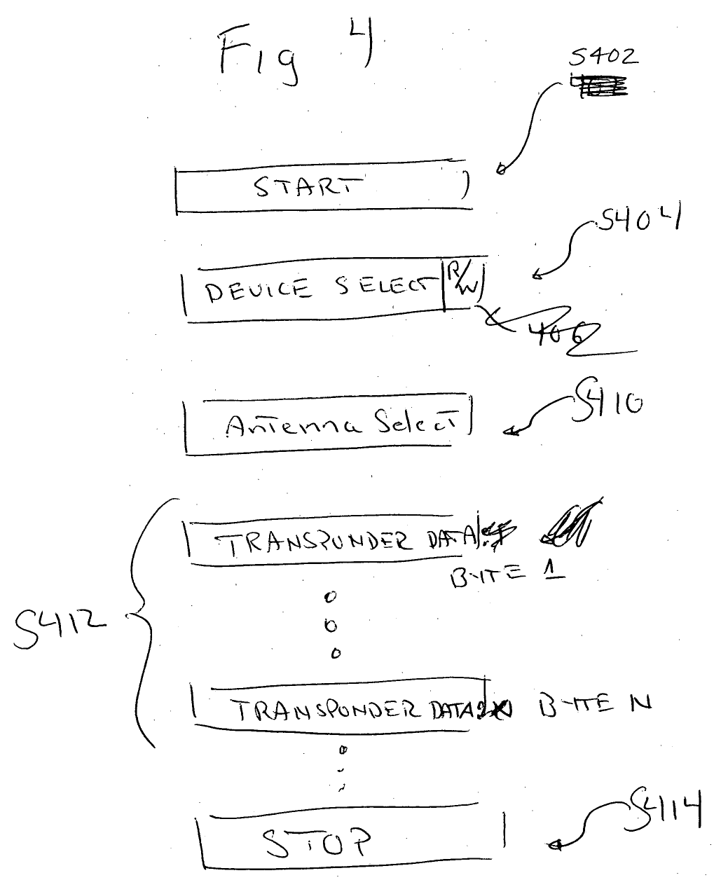

In the following scenario, the host computer 202 interrogates the transponder 222a to determine the status of toner in the toner bottle 302. As shown in the exemplary sequence of FIG. 4, the host computer 202 first transmits a start signal in step S402 over the I²C serial bus 228, alerting all slave devices of an impending message. Second, the host computer 202 transmits a data byte in step S404 to a particular radio frequency identification device 100, depending upon the state of lines E0-E2 116-120. In an exemplary embodiment, a separate bit of the data byte in step S404 may be a Read/Write flag that determines whether the host computer 202 is reading or writing to the RAM buffer 104.

If the appropriate radio frequency identification device 100 is selected, the host 202 computer may transmit a series of data bytes to the radio frequency identification device 100 over the I²C serial bus 228. As shown in step S410, one byte may be decoded by the external device select logic 106 to enable one specific antenna circuit via ports A0-A2 and signals 124-128.

After the proper antenna circuit 218a has been enabled, subsequent data bytes may be transmitted in step S412 by the host computer 202 to the radio frequency identification device 100 over the I²C serial bus 228 and transformed to an RF signal 130 on port RF OUT. The RF output 130 may be amplified and filtered before being gated through the demultiplexer 216 to excite antenna circuit 218a and the sensing antenna 220a. A stop command in step S414 from the host computer 202 completes the transmission.

The outputs of antenna circuits 218a-e may be cabled to their associated antennas 220a-e. The distance from the tuning circuit to the antenna may be kept as short as possible to minimize the effect of the cable on the output power and impedance of the antenna.

A plurality of radio frequency identification transponders 222a-e, in close proximity to sensing antennas 220a-e, may comprise electronic data-carrying devices, such as a single microchip, and a large area coil 224a-e serving as an antenna. With the antenna circuit 218a active, the antenna 220a may generate a magnetic field which penetrates the antenna coil 224a of the proximate radio frequency identification transponder 222a, inductively coupling transponder coil 224a to the sensing antenna 220a, drawing energy from the magnetic field. Switching a load on and off at the antenna 224a of transponder 222a may change the impedance of the antenna 220a and have a loading effect on the RF signal 230a. RF signals 230a-e may be gated onto signal 136, which may serve as an input to filter 210. Filter output 132 may be fed into the RF IN port of the radio frequency identification device 100. The radio frequency identification device 100 may demodulate the signal 132 and the resultant digital data may be stored in RAM Buffer 104.

Once the host computer 202 has transmitted data to the appropriate radio frequency identification transponder, the host computer 202 may read the radio frequency identification transponder data stored by the radio frequency identification device 100. The host computer 202 may initiate a read command by transmitting a start command followed by a data byte that both selects the appropriate radio frequency identification device and reads the appropriate RAM register. The radio frequency identification device 100 may respond by transmitting the stored transponder data to the host computer 202 over the I²C serial bus 228.

While particular embodiments have been described, these embodiments should be viewed as illustrative, and not limiting.

What is claimed is:

1. A radio frequency identification device comprising:
a first serial bus controller configured to transmit and receive digital data to and from a host;
an analog transmitter configured to receive digital data from the first serial bus controller and to provide a radio frequency signal to a plurality of radio frequency antenna circuits;
an analog receiver configured to receive a radio frequency signal from the plurality of radio frequency antenna circuits and to transmit digital data to the first serial bus controller;
external device selection logic configured to receive antenna selection data from the first serial bus controller and to select one of a plurality of external devices; and
a state machine circuit that controls the manipulation of data within the radio frequency identification device.

2. The radio frequency identification device of claim 1, wherein the first serial bus controller comprises a bidirectional data bus.

3. The radio frequency identification device of claim 1, wherein the first serial bus controller comprises a two-wire Inter-Integrated Circuit (I²C) bus interface.

4. The radio frequency identification device of claim 1, wherein the external device selection logic provides signals determined by the state machine operating on data received from the first serial bus controller.

5. The radio frequency identification device of claim 1, wherein the analog receiver and the analog transmitter each comprise an ISO 14443 compliant analog interface.

6. The radio frequency identification device of claim 1, wherein the external device selection logic comprise three encoded output ports configured to select one of eight external devices at a time.

7. The radio frequency identification device of claim 1, further comprising an image forming apparatus, the image forming apparatus comprising:
an image forming part for forming an image;
at least one customer replaceable unit, the replaceable unit having a radio frequency identification transponder attached thereto; and
a radio frequency identification reader associated with the image forming apparatus, the at least one sensing antenna in close proximity to the radio frequency identification transponder;
whereby a host computer monitors the status of the at least one customer replaceable unit via the transponder and the radio frequency identification reader.

8. A method of selectively interrogating a plurality of radio frequency identification transponders, the method comprising:
providing a plurality of radio frequency identification transponders;
providing a plurality of sensing antennas, at least one of the sensing antennas being in close proximity to each radio frequency identification transponder;
providing a radio frequency identification device having a first serial bus controller, a radio frequency receiver, a radio frequency transmitter, and a plurality of digital output ports configured to enable one of the plurality of sensing antennas;
providing a host computer having a second serial bus controller that provides serial data communication with the first serial bus controller of the radio frequency identification device;
providing antenna select control logic in electrical communication with the radio frequency identification device and the plurality of radio frequency identification sensing antenna;
transmitting antenna selection data in serial form from the host computer to the radio frequency identification device;
decoding the serially received antenna selection data;
configuring the plurality of digital output ports to enable one of the plurality of sensing antennas; and
enabling one of the plurality of sensing antennas to communicate with a radio frequency identification transponder.

9. The method of claim 8, further comprising:
transmitting radio frequency identification transponder specific data from the host computer to the radio frequency identification device;
transforming the host transmitted transponder data to a radio frequency output signal; and
directing the radio frequency output signal to the enabled sensing antenna.

10. The method of claim 8, further comprising inducing transponder generated data on the enabled sensing antenna.

11. The method of claim 10, further comprising:
demodulating the transponder induced data within the radio frequency identification device; and
transmitting the demodulated data from the first serial bus controller of the radio frequency identification device to the second serial interface of the host computer.

12. The method of claim 8, further comprising transmitting ISO 14443 type B compliant radio frequency identification transponder data.

13. The method of claim 8, further comprising transmitting and receiving serial data between the first serial bus controller and the second serial bus controller over an I²C compliant data bus.

14. The method of claim 8, wherein the radio frequency identification device further comprises enabling one of eight radio frequency identification sensing antennas.

15. A radio frequency identification system, the system comprising:
a radio frequency identification device, the radio frequency identification device including a first serial bus controller, an analog output port configured to generate a radio frequency output signal, an analog input port configured to receive a radio frequency input signal, a plurality of digital output ports, and a state machine controlling manipulation of data within the radio frequency identification device;
a host computer having a second serial bus controller in electrical communication with the first serial bus controller;
filtering and amplifying circuitry in electrical communication with the radio frequency identification device;
a plurality of radio frequency identification transponders attachable to items to be monitored;
a plurality of sensing antennas, each of the plurality of sensing antennas in close proximity to one of the plurality of radio frequency identification transponders; and
control logic in electrical communication with the radio frequency identification device and the filtering and amplifying circuitry, the control logic providing a radio frequency output signal that drives one of the plurality of sensing antennas such that a single sensing antenna is driven at any one time.

16. The radio frequency identification device of claim 15, wherein the first serial bus controller comprises a bidirectional bus controller.

17. The radio frequency identification system of claim 15, wherein the first serial bus controller comprises an Inter-Integrated Circuit (I²C) interface.

18. The radio frequency identification system of claim 15, wherein the plurality of digital output ports provide signals determined by the state machine operating on data received over the first serial bus controller.

19. The radio frequency identification system of claim 15, wherein the plurality of digital output ports comprise three digital output ports configured to enable one of eight antennas at any one time.
